(19) United States
(12) Patent Application Publication
(10) Pub. No.: US 2003/0115272 A1
(43) Pub. Date: Jun. 19, 2003

(54) System and method for providing targeted e-mail

(76) Inventors: Norman Muttitt, Dallas, TX (US); Ladonna Sumpter, Dallas, TX (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 10/014,450

(22) Filed: Dec. 14, 2001

(51) Int. Cl. G06F 15/16; G06F 17/60

(52) U.S. Cl. 709/206; 705/14

(57) ABSTRACT

A targeted e-mail system and method for developing multiple pieces of targeted email content for patrons. The system includes a plurality of patrons and a number of subsystems that are integrated to provide the targeted e-mail. A merchant receives news items and special offers from internal and external content providers, and this content is targeted to the merchant's patrons via a targeted e-mail application subsystem. The system may capture information regarding each patron at its web site, and this data may include the patron's e-mail address, subscription flags, and other personal information. The merchant enters the content into the system using a content management subsystem. The targeting, or matching, of the content to the customers is accomplished by use of a datamart subsystem. The targeted e-mail application subsystem then prioritizes the content according to a predetermined display priority, and merges multiple matching pieces of content with each of the corresponding customers. The targeted e-mail application subsystem may also limit the number of offers provided in each e-mail. Furthermore, the targeted e-mail application subsystem may provide different categories of offers and limit the number of offers to be provided within each category. The resulting information is transferred to an e-mail vendor subsystem for delivery to the customers.

### BACKGROUND OF THE INVENTION

1. Field of the Invention

This invention relates to a system and method for developing targeted e-mail content for patrons, and more specifically to a system and method for matching multiple pieces of content to specific patrons and prioritizing the offers for ultimate delivery in a single e-mail to the patrons.

2. Related Art

In recent years, the exchange of information and products over networks, particularly public networks, such as the Internet, has become commonplace. Users of the Internet are able to access a wealth of information on a great range of topics, as well as buy and sell an almost endless variety of products and services. These options are available as a result of various systems connected to the Internet. These network-based systems are of varying size and complexity, and may be operated by anyone from one or a few individuals to huge corporate entities.

Today, systems that are accessible from the Internet relate to nearly every imaginable field. One commercial area to which these systems have been directed is advertising. Systems that can attract consumers and other Internet users effectively and in the most efficient manner will enjoy significant advantages. At the same time, non-network-based entities continue to rely on advertising via radio, television, print, etc., for promotion of a variety of products and services. These forms of marketing can be expensive and the results of the campaigns can be difficult to measure.

Merchants providing similar goods and/or services must compete for customers through advertising. As the number of different forms of advertising grows, the competition for customers becomes more intense. Therefore, merchants must seek advertising campaigns that are marketed to attract and retain customers in the most customer-friendly and cost-efficient manner possible. Merchants must also seek campaigns that can provide some measure of success or failure of each campaign.

Systems are known which provide advertising-related materials to patrons via email. Unfortunately, each of these systems suffers numerous drawbacks. Once such system provides blanket e-mails to patrons. These e-mails may provide promotional information regarding the merchant's products, and they are sent to a specified group of the merchant's patrons. In this way, all of the merchant's patrons who are listed as recipients receive the same e-mail having identical content.

Targeted e-mail is another tool that merchants use to communicate with their patrons about offers and other information that may be of interest to them. Unlike blanket e-mails, targeted e-mails are customized, with the expectation of providing the patrons with a good experience in dealing with the merchant. Because the e-mails are targeted to each patron's interest, there is also the expectation that patrons will become more enthusiastic about repeating their experiences with the merchant.

In present systems for developing targeted e-mail content, a merchant can target its message to an interested subset of its patrons. For example, a pet store can send an email regarding cat food to a cat owner and send a different e-mail regarding dog food to a dog owner. A patron's involvement begins at the time the patron signs up to participate in the merchants e-mail program, at which time the patron provides the merchant with personal information to create a personal profile. The patron is allowed to update and modify information in their personal profile, which helps the merchant to support a more personalized system of communicating with the patron.

Also in present systems for developing targeted e-mail, datamarts are used to extract and store content, and to attach lists of patrons to pieces of content using a merchant's business rules. For example, the E.PIPHANY® datamart selects a set of patrons using a business rule such as “If tier status is platinum.” The datamart then generates a campaign, which is an offer targeted to a specific segment of patrons. An example of a campaign is “Double miles for all flights to Chicago” that would be offered to all platinum level program members. A campaign may include one or more offers or other pieces of content. However, in present systems, once a patron qualifies for one offer in a campaign, that patron is disqualified from subsequent offers within that campaign. Therefore, in a single campaign, only one offer or other piece of content can be sent to each patron.

One drawback of the approach used in present targeted e-mail systems is that there are limitations on the manipulation of the content to be included in the e-mail. To illustrate this drawback, consider the following example: A merchant wants to make two offers based on certain criteria to its patrons within a single campaign. One offer might be “fly 5 times in the next 12 months and receive 20,000 bonus miles.” A second offer might be “fly from Dallas to Tokyo and take a companion for free.” The criteria for the first offer might be anyone who has flown within the last 6 months, and the criteria for the second offer might be any one who has flown to Japan from Dallas or from Dallas to Japan within the last 24 months. In present systems, the merchant could not present the two offers to a patron qualifying for both offers within one campaign (i.e., a patron who has flown from Dallas to Tokyo or from Tokyo to Dallas). That is to say, the merchant could only send one offer to each qualified patron because once a patron qualifies for one offer in a single campaign, he or she is disqualified from subsequent offers or other pieces of content.

It is therefore an object of the present invention to provide a system and method for providing multiple offers to a patron within a single targeted e-mail.

It is also an object of the present invention to provide a system and method for prioritizing offers in targeted e-mails, based on specific criteria, thereby placing the offers in order from the most important to the least important.

It is also an object of the present invention to provide a system and method for limiting the number of offers to be provided in targeted e-mails.

It is also an object of the present invention to provide a system and method for providing different categories of offers in targeted e-mails.

It is also an object of the present invention to provide a system and method for limiting the number of offers to be provided within each category in targeted e-mails.

### SUMMARY OF THE INVENTION

In accordance with the present invention, there is provided a method for providing different combinations of multiple pieces of content in a single e-mail to a plurality of patrons. The method includes maintaining a database identifying each of the patrons and each patron's corresponding interest, matching the multiple pieces of content to each of the patrons based on each patron's individual corresponding interest, generating the single e-mail for each of the patrons, wherein the e-mail contains the multiple pieces of content, and delivering the e-mail to each of the patrons.

Optionally, the method may also include prioritizing the multiple pieces of content for placement in the e-mail, limiting the number of pieces of content to be provided in the targeted e-mail, and/or eliminating duplicate pieces of content.

In addition, the method may optionally include sorting the multiple pieces of content into defined categories. The method may further include limiting the number of pieces of content to be provided within each of the defined categories.

There is also provided a system for providing different combinations of multiple pieces of content in a single e-mail to a plurality of patrons. The system includes a mechanism for maintaining a database identifying each of the patrons and each patron's corresponding interest, a mechanism for matching the multiple pieces of content to each of the patrons based on each patron's individual corresponding interest, a mechanism for generating the single e-mail for each of the patrons, where the e-mail contains the multiple pieces of content and a mechanism for delivering the e-mail to each of the patrons.

Optionally, the system may further include a mechanism for prioritizing the multiple pieces of content for placement in the e-mail, a mechanism for limiting the number of pieces of content to be provided in the targeted e-mail, and/or a mechanism for eliminating duplicate pieces of content.

In addition, the system may optionally include a mechanism for sorting the multiple pieces of content into defined categories. The system may further include a mechanism for limiting the number of pieces of content to be provided within each of the defined categories.

There is also provided a system for providing multiple pieces of content in a single e-mail, where the system includes a plurality of patrons and a processor. In the system, the processor may be programmed to maintain a database identifying each of the patrons and each patron's corresponding interest, match the multiple pieces of content to each of the patrons based on each patron's individual corresponding interest, generate the single e-mail for each of the patrons, where the e-mail contains the multiple pieces of content, and deliver the e-mail to each of the patrons.

Optionally, the processor may be further programmed to prioritize the multiple pieces of content for placement in the e-mail, limit the number of pieces of content to be provided in the targeted e-mail, and/or eliminate duplicate pieces of content.

In addition, the processor may optionally be further programmed to sort the multiple pieces of content into defined categories. The processor may further be programmed to limit the number of pieces of content to be provided within each of the defined categories.

There is also provided a system for providing multiple pieces of content in a single e-mail, where the system includes a number of subsystems. The system may include a content management subsystem that receives content as input and deploys the content into a first database. The system may also include a datamart subsystem that extracts content from the first database and one or more other databases and matches a plurality of patrons to a single piece of content, based on each patron's corresponding interest. Moreover, the system may include a targeted e-mail application subsystem that merges each single piece of content matched to each of the plurality of patrons, so as to provide a single e-mail having multiple pieces of content for each of the plurality of patrons. The system also may include an e-mail vendor subsystem that distributes the targeted e-mail to each of the plurality of patrons.

Optionally, the system may prioritize the multiple pieces of content for placement in the e-mail, limit the number of pieces of content to be provided in the targeted e-mail, and/or eliminate duplicate pieces of content.

In addition, the system may optionally sort the multiple pieces of content into defined categories. The system may also limit the number of pieces of content to be provided within each of the defined categories.

Other systems, methods, features, and advantages of the invention will be or will become apparent to one skilled in the art upon examination of the following figures and detailed description. It is intended that all such additional systems, methods, features, and advantages be included within this description, be within the scope of the invention, and be protected by the accompanying claims.

### DESCRIPTION OF THE DRAWINGS

FIG. 1 is a block diagram of a computer system that provides the operating environment for an illustrative embodiment of the present invention.

FIG. 2A is a block diagram illustrating the interaction between the merchant, the patrons, and the subsystems of the targeted e-mail system; FIG. 2B is a block diagram illustrating the targeted e-mail system architecture.

FIG. 3 is a flowchart illustrating the process flow of the database storage and manipulation tool subsystem and the targeted email application subsystem.

FIG. 4A is a flowchart illustrating a method of processing the distribution list in the targeted e-mail application subsystem; FIG. 4B is a flowchart illustrating a method of detecting errors in the targeted e-mail application subsystem.

### DETAILED DESCRIPTION OF THE PREFERRED EMBODIMENTS

The present invention is directed to a system and method for developing targeted e-mail content for patrons, matching the content to specific patrons, and prioritizing the offers for ultimate delivery to the patrons. Although the examples provided relate to travel, the system and method may be applicable to other merchant and patron relationships.

The targeted e-mail system includes several subsystems, which are integrated to provide personalized e-mail messages to the targeted recipients. First, however, in order to communicate offers directly to the appropriate patrons, the merchant must obtain information about the patron. This information may be obtained either directly or indirectly from the patron. For instance, a merchant may have a website that allows the patron to specify markets as well as types of products and services that appeal to that patron. Other ways the merchant may obtain information is by monitoring the patron's flight behavior, website behavior, specified preferences, and program status. In the meantime, the merchant may receive news items and special offers from content providers, both internal and external to the merchant. The merchant provides the content of the offers and/or news items to the system via a content management subsystem.

Once the content is created, the data is deployed into a database. Next, the data is extracted from the database via a database storage and manipulation tool, such as a datamart subsystem. The data is stored in the datamart, and is manipulated such that lists of patrons are attached to the pieces of content using the merchant's business rules. That is to say, multiple campaigns are run resulting in one offer being attached to each patron. A record is generated for each patron per offer. A targeted e-mail application subsystem takes the lists generated by the datamart subsystem, and produces one record per patron, including one or more pieces of content.

The criteria used to target patrons may be simple, such as “if status equals platinum.” However, one skilled in the art would know that more complex targeting criteria may be used. For example, the system may target patrons by determining whether the patron resides in Toronto, Boston, or the state of New Hampshire AND has traveled to Florida in the last 18 months OR has a favorite city of Fort Lauderdale, Tampa, or Miami AND has purchased three or more first class tickets in the last 12 months.

The order of placement within the e-mail is prioritized for display to the patron. Also, the targeted e-mail application subsystem may limit the number of offers to be presented to the patrons. In an embodiment of the system, the datamart subsystem records all the offers that a customer is eligible to receive. In a preferred embodiment of the system, the datamart subsystem may be updated to reflect only those offers that the patron actually received. An e-mail vendor subsystem may be used to update the datamart by reporting the click-through behavior of each patron. In either embodiment of the system, the e-mail vendor subsystem takes the output from the targeted e-mail application and places it in the e-mail for distribution to the patron.

In another embodiment, the system may update the datamart subsystem with the click-through data obtained after each mailing. The e-mail vendor subsystem captures this information and stores it in the datamart. In this way, the merchant can monitor the effectiveness of the campaign and can also use the data as selection criteria for future mailings. For example, a campaign may be run targeting “all the patrons that responded to the Hawaii cruise offer.” In yet another embodiment, the system may sort the offers into different pre-defined categories. For example, there may be one category related to rental cars and a second category related to hot news. In yet another embodiment, the system may limit the number of offers or content provided within each category. That is to say, the number of offers related to rental cars may be limited to two while the number of offers related to hot news may be limited to five.

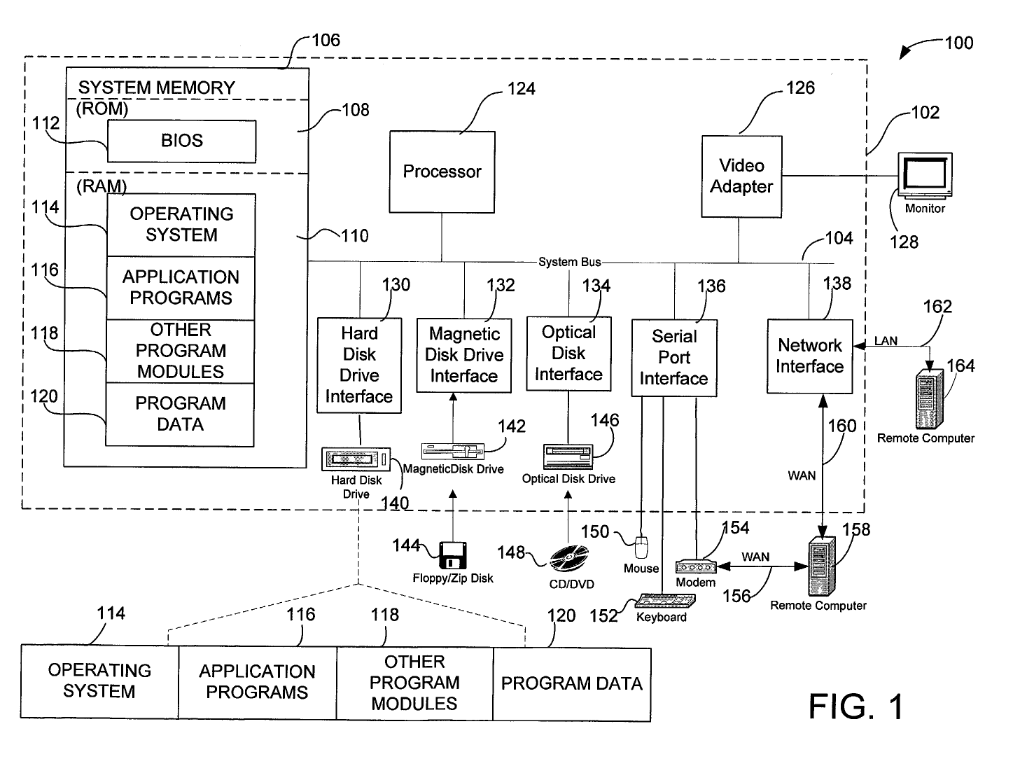

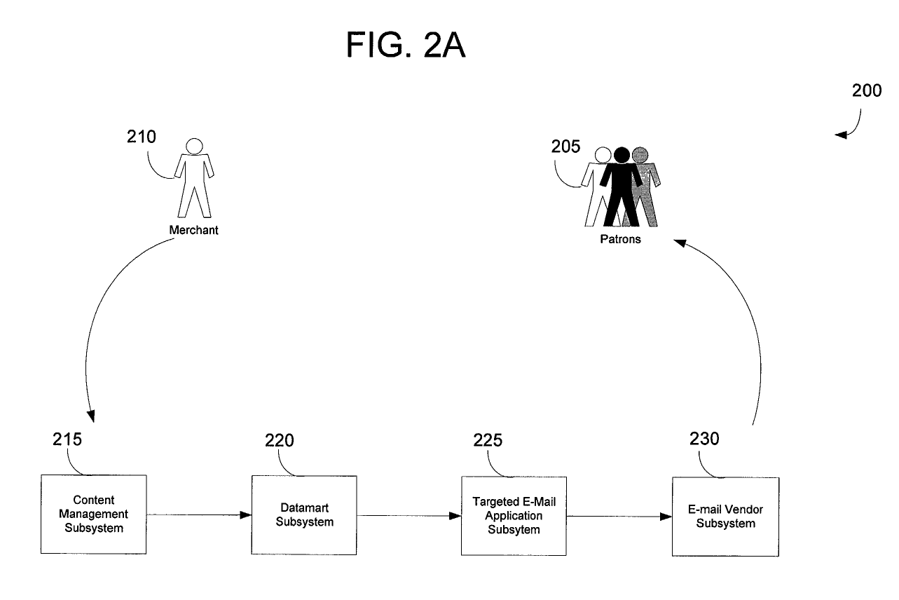

Turning now to the figures, FIG. 1 and the following discussion are intended to provide a brief, general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an illustrative system for implementing the invention includes a conventional personal computer 102, including a processor 124, a system memory 106, and a system bus 104. The system bus 104 couples the system memory to the processor 124. The system memory 106 includes read only memory (ROM) 108 and random access memory (RAM) 110. A basic input/output system 112 (BIOS), containing the basic routines that help to transfer information between elements within the personal computer 102, such as during start-up, is stored in ROM 108. The personal computer 102 further includes a local hard disk drive 140, a magnetic disk drive 142, for reading from or writing to a removable disk, and an optical disk drive 146, for reading a CD-ROM disk 146, or for reading from or writing to other optical media. The hard disk drive 140, the magnetic disk drive 142, and the optical disk drive 146 are connected to the system bus 104 by a hard disk drive interface 130, a magnetic disk drive interface 132, and an optical disk drive interface 134, respectively. The drives and their associated computer-readable media provide nonvolatile storage for the personal computer 102. Although the description of computer-readable media above refers to a hard disk, a removable magnetic disk, and a CD-ROM disk, those skilled in the art will appreciate that other types of media which are readable by a computer, such as magnetic cassettes, flash memory cards, digital video disks, Bernoulli cartridges, and the like may also be used in the illustrative operating environment of FIG. 1.

A number of program modules may be stored in the drives and RAM 110, including an operating system 114, one or more application programs 116 (e.g., word processing applications, content management applications, e-mail vendor applications, and datamart applications), other program modules 118 (e.g., a speech recognition engine and/or a voice recognition engine), and program data 120. The program data 120 on local hard disk drive 140 may constitute content derived from the content management application or speech data used in connection with the speech recognition engine and/or the voice recognition engine.

A user of computer 102 may enter commands and information into the personal computer 102 through a keyboard 152, and a pointing device, such as a mouse 150. Other input devices (not shown) may include a microphone, joystick, satellite dish, scanner, or the like. These and other input devices are often connected to the processor 124 through a serial port interface 136 that is coupled to the system bus, but may be connected by other interfaces, such as a game port, a microphone input, or a universal serial bus (USB). A monitor 128 or other type of display device is also connected to the system bus 104 via an interface, such as a video adapter 126. In addition to the monitor, personal computers typically include other peripheral output devices (not shown), such as speakers, printers, or other devices known in the art.

The personal computer may operate in a networked environment using logical connections to one or more remote computers, such as remote computers 158 and 164. The remote computers 158 and 164 may be servers, routers, peer devices, or other common network nodes, and the remote computers 158 and 164 typically include many or all of the elements described relative to the personal computer 102. The logical connections to computers 158 and 164 depicted in FIG. 1 include a local area network (LAN) 162 and wide area networks (WAN) 156 and 160. Such networking environments are commonplace in offices, enterprise-wide computer networks, intranets, and the Internet.

When used in a LAN networking environment, the personal computer 102 is connected to the LAN 162 through a network interface 138. When used in a WAN networking environment, the personal computer 102 typically includes a modem 154 or other means for establishing communications over the WAN. The modem 154, which may be internal or external, is connected to the system bus 104 via the serial port interface 136. A WAN connection may also be made through the network interface 138 to WAN 156. In a networked environment, program modules depicted relative to the personal computer 102, or portions thereof, may be stored in the remote memory storage device. Particularly, each remote computer 158 and 164 and their respective storage devices (not shown) can be searchable information repositories. Those of ordinary skill in the art will appreciate that the network connections shown are illustrative, and other means of establishing a communications link between the computers may be used.

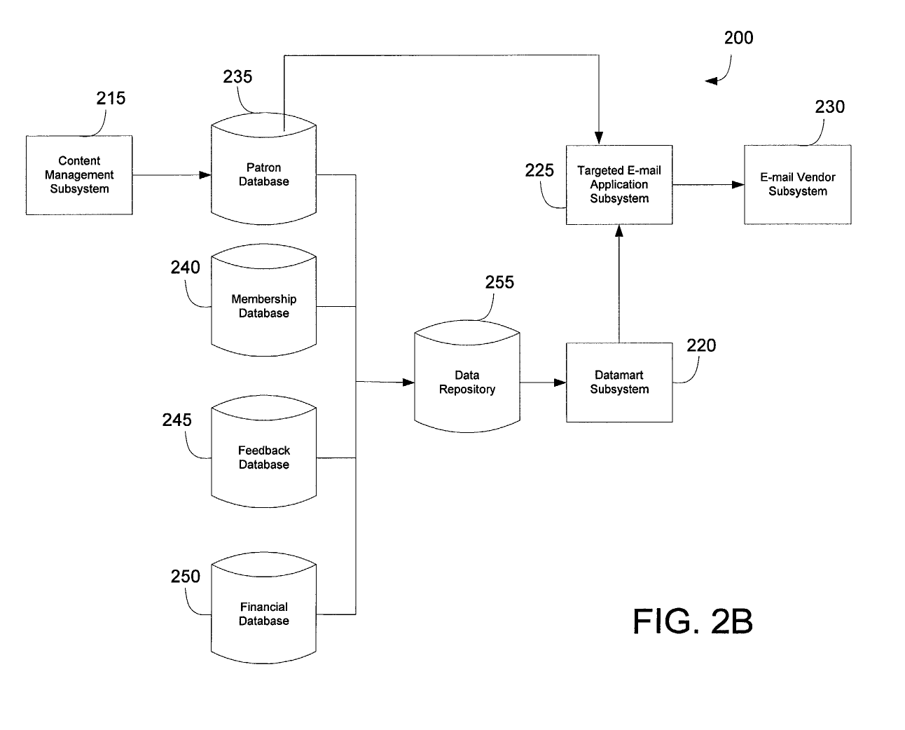

As illustrated in FIG. 2A, the present invention relates to a targeted e-mail system 200 involving a plurality of patrons 205, a merchant 210, and a plurality of subsystems 215, 220, 225, and 230, which are integrated to provide personalized e-mail messages to the targeted recipients. The merchant 210, which may include one or more users of system 200, provides content to the content management subsystem 215. This content may include news and/or special offers from both internal and external sources. The content may also include a title describing the content, the author, the date the content should be made available online, or any other identifying information regarding the news and/or special offers. The content management subsystem 215 may be a web-based program, such as INTERWOVEN®, or any other known content management program.

Once the content is created, it is transferred to a database. The datamart subsystem 220 extracts content from the database, and uses the merchant's business rules to attach lists of patrons to pieces of content. For example, a business rule may state that if a patron is a Gold Club member, then provide content regarding free seat upgrades. The subsystem 220 may also rely upon information contained in one or more other databases. The subsystem 220 generates a record for each patron, where each record contains one piece of content. Multiple campaigns are run on a one-for-one basis with each offer. The subsystem 220 may be a web-based program, such as E.PIPHANY®, or any other datamart that operates as a database storage and manipulation tool.

The targeted e-mail application subsystem 225 is a custom-developed application that receives as input all the lists generated by the datamart subsystem 220. Using constraints imposed by the merchant (e.g., priorities of offers and limitations of offers to 10 per patron), the targeted e-mail application system 225 produces one record per patron. Each record shows the pieces of content that the patron should see and how each piece of content is to be displayed in the e-mail. This record is formatted in the way the e-mail vendor subsystem 230 needs to receive the information. If duplicate offers have been provided, the targeted e-mail application subsystem 225 ignores the second offer.

The e-mail vendor subsystem 230 receives the output from the targeted e-mail application subsystem 225. It then places the output in the e-mail for distribution to the patrons 205. The e-mail vendor subsystem 230 may be any known e-mail vendor such as INTERELATE®.

FIG. 2B illustrates the targeted e-mail system architecture, and shows how each of the subsystems 215, 220, 225, and 230 work together to develop and distribute targeted email. Once the content is provided to the content management subsystem 215, it may be stored in a patron database 235 that contains information about each patron or program member. The patron database 235 may also contain response data received from the user at the merchant's website, such as the user address and account information. The system 200 may include any number of other data sources, such as a membership database 240 that may contain a patron's membership information, historical records, and every way a patron and/or program member has redeemed miles. A separate feedback database 245 may be included that may include the click-through information that is gathered from a program member's responses to e-mail solicitations. This feedback database 245 may also include information regarding a program member's desire to subscribe or unsubscribe to the e-mail program, undeliverable message notifications (i.e., bounce messages), and HTML enabled e-mail tracking information. A financial database 250 may be used to record each financial transaction made on the merchant's website. It should be noted that a variety of data sources may be used in determining which patrons will receive targeted e-mail messages. However, the patron database 235 is the principal database for the system. Although the patron database 235 provides limited selection criteria, it is the only database required. The membership database 240, feedback database 245, and financial database 250 are provided for illustrative purposes only, and additional or different data sources may be added as needed.

Data is extracted from the data sources 235, 240, 245, and 250, and stored in the data repository 255 of the datamart subsystem 220. The datamart subsystem 220 receives the data and uses it to attach lists of patrons to the pieces of content using the merchant's business rules. One offer per patron is generated, and the resulting files are transferred to the targeted e-mail application subsystem 225. The targeted e-mail application subsystem 225 pulls content from the patron database 235, which may include information provided by the merchant regarding how to prioritize the offers and the maximum number of offers to make to each patron. The information provided by the merchant may also include different categories of offers, and it may also include the maximum pieces of content to include within each category. The targeted e-mail application subsystem 225 uses the content from the patron database 235 and the output from the datamart subsystem 220 to produce one record per patron, where each record includes the pieces of content the patron should see and the order in which the patron should see the pieces of content. The number of offers may be limited to a predetermined number, as provided by the merchant. The records are transferred to the e-mail vendor subsystem 230, which places the content in the e-mail for distribution to the patrons.

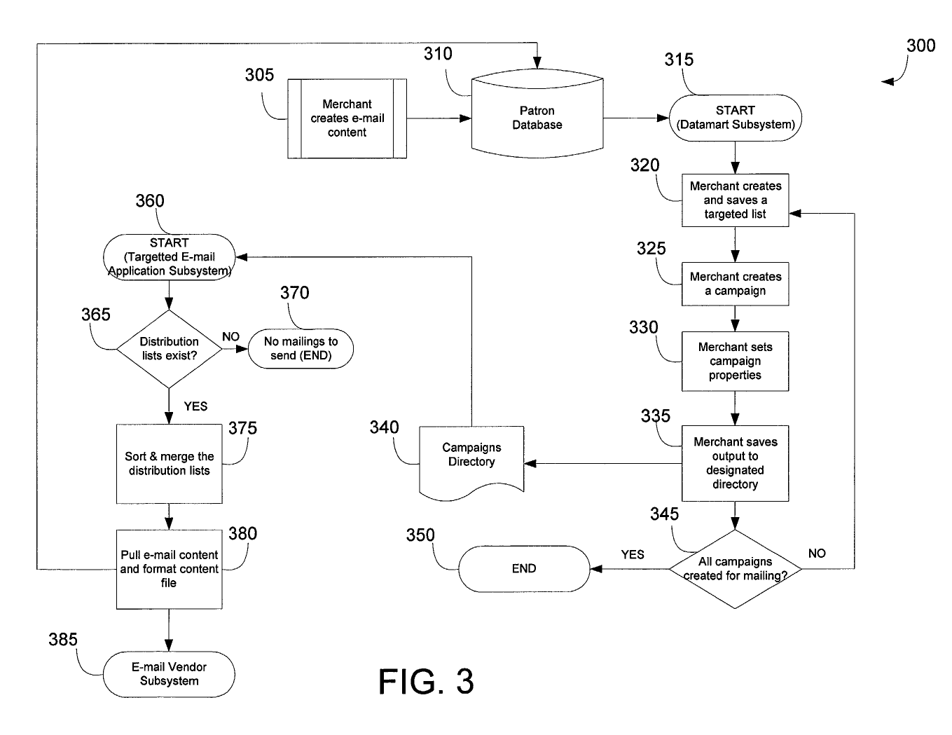

FIG. 3 shows the process flow of the interaction between the datamart subsystem and the targeted e-mail application subsystem. The method 300 begins at step 305, where the merchant creates e-mail content, which is stored in the patron database 310. The datamart subsystem is triggered in start step 315, and method 300 then proceeds to step 320. In step 320, the merchant creates and saves a targeted list of patrons using the data extracted from one or more data sources, such as the patron database 310. As discussed above with regard to FIG. 2, there may be any number of data sources, but at least one data source, such as the patron database 310 is required. In step 325, the merchant creates and saves a campaign, which may include one or more pieces of content. The merchant assigns the campaign to the targeted distribution list in step 330, and the method proceeds to step 335, where the merchant saves the output in a predefined output format to a designated directory 340 (campaigns directory). Next, in decision step 345, the system determines whether there are other campaigns that should be assigned to a targeted list. If all the campaigns have not been assigned, then method 300 loops back to step 320 and repeats steps 320, 325, 330, 335, and 345. However, if all the campaigns have been assigned, then the method 300 proceeds to end step 350.

Next, the targeted e-mail application subsystem is triggered in start step 360. Once triggered, the subsystem polls the campaigns directory, and proceeds to decision step 365 where it determines whether any distribution lists exist. If there are no distribution lists, then the method proceeds to step 370, and the process ends. However, if there are existing distribution lists, the method proceeds to step 375 to sort and merge the distribution lists. In step 380, the subsystem pulls the e-mail content from the patron database 310 and formats the content file. The method 300 then proceeds to step 385, where it provides the content file to the e-mail vendor subsystem for distribution.

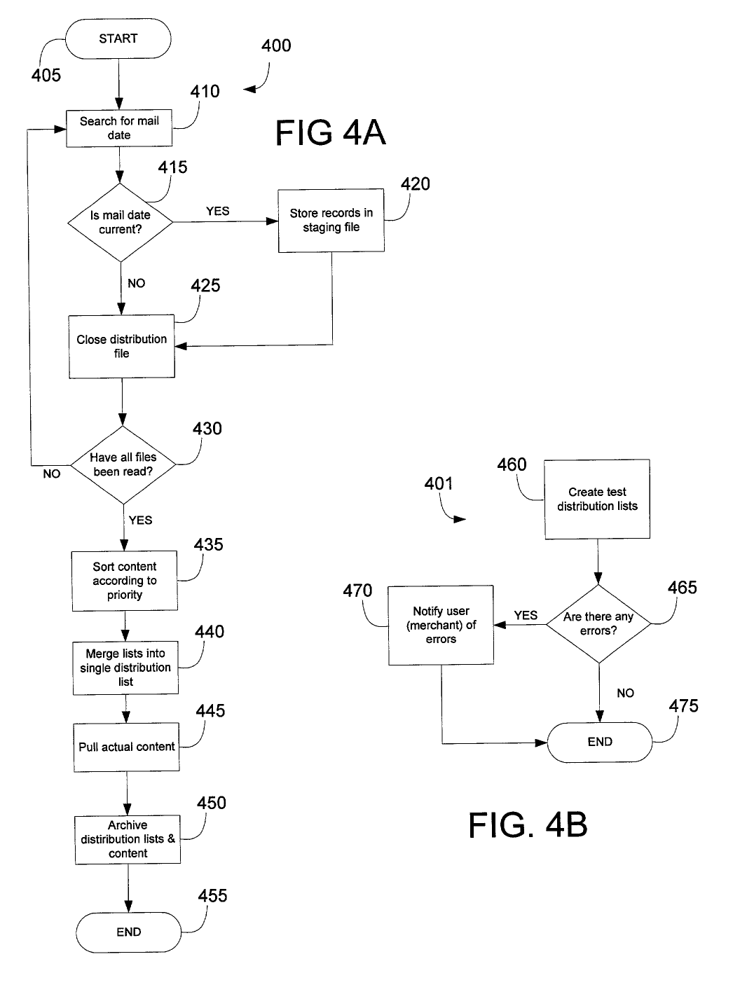

FIG. 4A is a flowchart illustrating one method of processing the distribution lists in the targeted e-mail application subsystem. If distribution lists exist, then the method 400 is triggered at start step 405, and proceeds to step 410. In step 410, the targeted email application subsystem searches for the content's mail date to determine what mailing date is intended for the desired mailing. That is to say, the subsystem searches the distribution files found in the designated directory, which was provided by the datamart subsystem. In step 415, the method 400 determines whether the mail date is still current. If a distribution file has been cleared for processing (i.e., passed the date check), then in step 420, the distribution list will be loaded into a targeted e-mail application subsystem staging file. The method then proceeds to step 425 and closes the distribution file. If the distribution file is not cleared for processing, the method 400 proceeds directly to step 425 and closes the distribution file. Next, in decision step 430, the subsystem determines whether all of the files have been read. If not, then the method 400 loops back to step 410, and steps 410, 415, 420, 425, and 430 are repeated until all the files have been read. At that time, the method 400 proceeds to step 435, where the targeted e-mail application subsystem sorts the content according to the display priority, which was originally defined during content creation. The subsystem may also sort the content in defined categories and limit the number of pieces of content to be included in each category. In addition, the subsystem may limit the total number of pieces of content to be included in the entire e-mail. In step 440, the subsystem merges all of the lists into a single distribution list, and formats the single distribution list for the e-mail vendor subsystem. Patrons that appear on multiple distribution lists will appear as one record in the resulting file, with the matching multiple pieces of content attached. The method 400 proceeds to step 445, where the subsystem pulls the actual pieces of content from the patron database. This content may be pulled based upon a code, such as a treatment code identified for the mailing.

In another preferred method of processing the distribution list, the method 400 may then proceed to step 450, where the subsystem archives the content and distribution lists. The method 400 may also optionally delete existing distribution lists that are more than a predetermined number of days old. The method 400 ends at step 455.

FIG. 4B illustrates yet another preferred method of processing the distribution list, which is an error handling mechanism 401. This error handling mechanism 401 may be added to method 400. Before reaching end step 455 of method 400, the targeted e-mail application subsystem may generate test distribution lists in step 460. These test distribution lists may encompass all valid offers. The test users may use this list for reviewing content. In decision step 465, the subsystem determines whether there were errors within the process of distributing the test lists. If there were errors, then in step 470, the user may be notified by e-mail.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A method for providing different combinations of multiple pieces of content in a single e-mail to a plurality of patrons, the method comprising:
maintaining a database identifying each of the patrons and each patron's corresponding interest;
matching the multiple pieces of content to each of the patrons based on each patron's individual corresponding interest;
generating the single e-mail for each of the patrons, wherein the e-mail contains the multiple pieces of content; and
delivering the e-mail to each of the patrons.

2. The method of claim 1, further comprising prioritizing the multiple pieces of content for placement in the e-mail.

3. The method of claim 2, further comprising limiting the number of pieces of content to be provided in the e-mail.

4. The method of claim 3, further comprising eliminating duplicate pieces of content.

5. The method of claim 2, further comprising sorting the multiple pieces of content into defined categories.

6. The method of claim 5, further comprising limiting the number of pieces of content to be provided within each of the defined categories.

7. A system for providing different combinations of multiple pieces of content in a single e-mail to a plurality of patrons, the system comprising:
means for maintaining a database identifying each of the patrons and each patron's corresponding interest;
means for matching the multiple pieces of content to each of the patrons based on each patron's individual corresponding interest;
means for generating the single e-mail for each of the patrons, wherein the e-mail contains the multiple pieces of content; and
means for delivering the e-mail to each of the patrons.

8. The system of claim 7, further comprising means for prioritizing the multiple pieces of content for placement in the e-mail.

9. The system of claim 8, further comprising means for limiting the number of pieces of content to be provided in the e-mail.

10. The system of claim 9, further comprising means for eliminating duplicate pieces of content.

11. The system of claim 8, further comprising means for sorting the multiple pieces of content into defined categories.

12. The system of claim 11, further comprising means for limiting the number of pieces of content to be provided within each of the defined categories.

13. A system for providing multiple pieces of content in a single e-mail, the system comprising:
a plurality of patrons; and
a processor programmed to:
maintain a database identifying each of the patrons and each patron's corresponding interest;
match the multiple pieces of content to each of the patrons based on each patron's individual corresponding interest;
generate the single e-mail for each of the patrons, wherein the e-mail contains the multiple pieces of content; and
deliver the e-mail to each of the patrons.

14. The system of claim 13, the processor being further programmed to prioritize the multiple pieces of content for placement in the e-mail.

15. The system of claim 14, the processor being further programmed to limit the number of pieces of content to be provided in the e-mail.

16. The system of claim 15, the processor being further programmed to eliminate duplicate pieces of content.

17. The system of claim 14, the processor being further programmed to sort the multiple pieces of content into defined categories.

18. The system of claim 17, the processor being further programmed to limit the number of pieces of content to be provided within each of the defined categories.

19. A system for providing multiple pieces of content in a single e-mail, the system comprising:
a content management subsystem, wherein the content management subsystem is adapted to receive content as input and is adapted to deploy the content into a first database;
a datamart subsystem, wherein the datamart subsystem is adapted to extract content from the first database and one or more other databases and is adapted to match a plurality of patrons to a single piece of content, based on each patron's corresponding interest;
a targeted e-mail application subsystem, wherein the targeted e-mail application subsystem is adapted to merge each single piece of content matched to each of the plurality of patrons, so as to provide a single e-mail having multiple pieces of content for each of the plurality of patrons; and
an e-mail vendor subsystem, wherein the e-mail vendor subsystem is adapted to distribute the targeted e-mail to each of the plurality of patrons.

20. The system of claim 19, wherein the targeted e-mail application subsystem is further adapted to prioritize the multiple pieces of content for placement in the e-mail.

21. The system of claim 20, wherein the targeted e-mail application subsystem is further adapted to limit the number of pieces of content to be provided in the e-mail.

22. The system of claim 21, wherein the targeted e-mail application subsystem is further adapted to eliminate duplicate pieces of content.

23. The system of claim 19, wherein the targeted e-mail subsystem is further adapted to sort the multiple pieces of content into defined categories.

24. The system of claim 23, wherein the targeted e-mail subsystem is further adapted to limit the number of pieces of content to be provided within each of the defined categories.
